(19) United States
(12) Patent Application Publication
(10) Pub. No.: US 2022/0252839 A1
(43) Pub. Date: Aug. 11, 2022

(54) COMPACT OPTICAL IMAGING DEVICE WITH SHORTENED FOCAL DISTANCE, IMAGING MODULE, AND ELECTRONIC DEVICE

(71) Applicant: HON HAI PRECISION INDUSTRY CO., LTD., New Taipei (TW)

(72) Inventors: GWO-YAN HUANG, New Taipei (TW); CHING-HUNG CHO, New Taipei (TW); CHIA-CHIH YU, New Taipei (TW)

(21) Appl. No.: 17/587,072

(22) Filed: Jan. 28, 2022

(30) Foreign Application Priority Data
Feb. 9, 2021 (CN) 202110180605.3

(51) Int. Cl. G02B 13/00; H04N 5/225

(52) U.S. Cl. CPC G02B 13/0035; H04N 5/2254; H04N 5/2252

(57) ABSTRACT

A compact optical imaging device with three individual lenses, able to capture clear images of both near and distant objects with a balance between imaging quality and sensitivity, and used in an imaging module and an electronic device, satisfies the formula 0 mm<R11<1 mm, −5%<DIS<5%, V1≥V2, V3≥V2, where R11 is a radius of curvature of an object-side surface of the first lens, DIS is optical distortion of the optical imaging device, V1 is a dispersion coefficient of the first lens, V2 is a dispersion coefficient of the second lens, and V3 is a dispersion coefficient of the third lens.

### FIELD

The subject matter relates to optical technologies, and more particularly, to an optical imaging device, an imaging module having the optical imaging device, and an electronic device having the imaging module.

### BACKGROUND

Portable electronic devices, such as computer-equipped vehicles, tablet computers, and mobile phones, may be equipped with optical imaging lenses. When the electronic devices become smaller, higher quality optical imaging lenses are needed.

At present, a compact optical imaging device generally use three lens elements therein. However, achieving a good balance between imaging quality and sensitivity with such optical imaging device is problematic.

### BRIEF DESCRIPTION OF THE DRAWINGS

Implementations of the present technology will now be described, by way of example only, with reference to the attached figures.

FIG. 1 is a diagrammatic view of a first embodiment of an optical imaging device according to the present disclosure.

FIG. 2 is a diagram of Modulation Transfer Function (MTF) curves of the optical imaging device in the first embodiment.

FIG. 3 is a diagram of field curvatures of the optical imaging device in the first embodiment.

FIG. 4 is a diagram of distortion of the optical imaging device in the first embodiment.

FIG. 5 is a diagrammatic view of a second embodiment of an optical imaging device according to the present disclosure.

FIG. 6 is a diagram of MTF curves of the optical imaging device in the second embodiment.

FIG. 7 is a diagram of field curvatures of the optical imaging device in the second embodiment.

FIG. 8 is a diagram of distortions of the optical imaging device in the second embodiment.

FIG. 9 is a diagrammatic view of a third embodiment of an optical imaging device according to the present disclosure.

FIG. 10 is a diagram of MTF curves of the optical imaging device in the third embodiment.

FIG. 11 is a diagram of field curvatures of the optical imaging device in the third embodiment.

FIG. 12 is a diagram of distortion of the optical imaging device in the third embodiment.

FIG. 13 is a diagrammatic view of a fourth embodiment of an optical imaging device according to the present disclosure.

FIG. 14 is a diagram of MTF curves of the optical imaging device in the fourth embodiment.

FIG. 15 is a diagram of field curvatures of the optical imaging device in the fourth embodiment.

FIG. 16 is a diagram of distortion of the optical imaging device in the fourth embodiment.

FIG. 17 is a diagrammatic view of a fifth embodiment of an optical imaging device according to the present disclosure.

FIG. 18 is a diagram of MTF curves of the optical imaging device in the fifth embodiment.

FIG. 19 is a diagram of field curvatures of the optical imaging device in the fifth embodiment.

FIG. 20 is a diagram of distortions of the optical imaging device in the fifth embodiment.

FIG. 21 is a diagrammatic view of an embodiment of an imaging module according to the present disclosure.

FIG. 22 is a diagrammatic view of an embodiment of an electronic device using an optical imaging device in one embodiment according to the present disclosure.

### DETAILED DESCRIPTION

It will be appreciated that for simplicity and clarity of illustration, where appropriate, reference numerals have been repeated among the different figures to indicate corresponding or analogous components. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The term “comprising,” when utilized, means “including, but not necessarily limited to”; it specifically indicates open-ended inclusion or membership in the so-described combination, group, series, and the like.

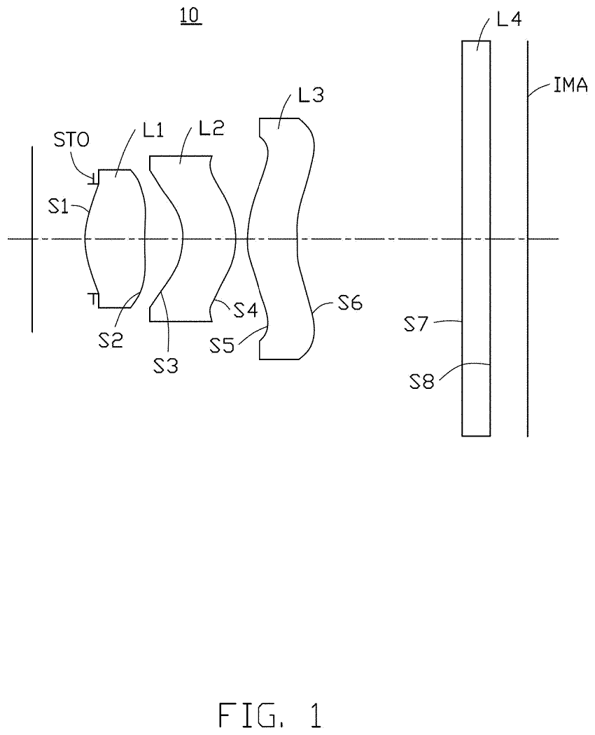

Referring to FIG. 1, a first embodiment of an optical imaging device 10 includes, from object side to image side, a first lens L1 having a refractive power, a second lens L2 having a refractive power, and a third lens L3 having a refractive power.

The first lens L1 includes an object-side surface S1 and an image-side surface S2. The second lens L2 includes an object-side surface S3 and an image-side surface S4. The third lens L3 includes an object-side surface S5 and an image-side surface S6.

Through the arrangement of different lenses in a compact space and the arrangement of the refractive power of each lens, the optical imaging device 10 has a small size, which can be applied in an electronic device of a small size.

In some embodiment, the optical imaging device 10 satisfies the following formulas (1):

0 mm<R11<1 mm, −5%<DIS<5%, V1≥V2, and V3≥V2 (formulas (1));

Wherein, R11 is a radius of curvature of the object-side surface S1 of the first lens L1, DIS is optical distortion of the optical imaging device 10, V1 is a dispersion coefficient of the first lens L1, V2 is a dispersion coefficient of the second lens L2, and V3 is a dispersion coefficient of the third lens L3. As such, the respective refractive indexes of the three lenses adopts a low-high-low combination mode, which can improve the imaging quality and reduce the sensitivity of the optical imaging device 10.

In some embodiment, the object-side surface S5 of the third lens L3 is convex near an optical axis of the optical imaging device 10, and the image-side surface S6 of the third lens L3 is concave near the optical axis.

In some embodiments,

the optical imaging device 10 satisfies the following formula (2):

0.1<P11<1, −10<P2<1, P3>−2 (formula (2));

Wherein, P11 is a refractive power of the object-side surface of the first lens L1, P2 is the refractive power of the second lens L2, and P3 is the refractive power of the third lens L3. Through arrangement of the refractive power of each lens, the total optical length of the optical imaging device 10 can be reduced.

In some embodiments, the optical imaging device 10 satisfies the following formula (3):

0.78<Imgh/f<1.60 (formula (3));

Wherein, Imgh is an image height corresponding to a half of a maximum field of view of the optical imaging device 10, and f is an effective focal length of the optical imaging device 10. As such, the optical imaging device 10 has a large viewing angle.

In some embodiments, the optical imaging device 10 satisfies the following formula (4):

1.36<(V2+V3)/V1<1.45 (formula (4));

Wherein, V1 is the dispersion coefficient of the first lens L1, V2 is the dispersion coefficient of the second lens L2, and V3 is the dispersion coefficient of the third lens L3. The balance achieved between chromatic aberration correction and astigmatism correction improves the imaging quality of the optical imaging device 10.

In some embodiments, the optical imaging device 10 satisfies the following formula (5):

1.04<TL1/f<1.45 (formula (5));

Wherein, TL1 is a distance from the object-side surface S1 of the first lens L1 to an image plane of the optical imaging device 10 along the optical axis, and f is the effective focal length of the optical imaging device 10. As such, a total track length of the optical imaging device 10 can be reduced, and the optical imaging device 10 has a large viewing angle.

In some embodiments, the optical imaging device 10 satisfies the following formula (6):

2.06<f/EPD<3.03 (formula (6));

Wherein f is the effective focal length of the optical imaging device 10, and EPD is an entrance pupil diameter of the optical imaging device 10. As such, the amount of light admitted to the optical imaging device 10 and the F-number of the optical imaging device 10 is controlled, so that the optical imaging device 10 can have a large aperture and a great depth of field, the optical imaging device 10 can clearly capture image of infinitely-distant objects and have high resolution for nearby objects, and the imaging quality of the optical imaging device 10 is improved.

In some embodiments, the optical imaging device 10 satisfies the following formula (7):

0.36<V2/V3<1 (formula (7));

Wherein V2 is the dispersion coefficient of the second lens L2 and V3 is the dispersion coefficient of the third lens L3. As such, chromatic aberration is corrected.

In some embodiments, the optical imaging device 10 also includes a stop STO disposed before the first lens L1. The stop can be a glare stop or a field stop, and reduce starry light and improve the imaging quality.

In other embodiments, the stop STO can also be sandwiched between any two lenses. The stop STO can also be disposed on the image-side surface S6 of the third lens L3.

In some embodiments, the optical imaging device 10 also includes an infrared filter L4. The infrared filter L4 includes an object-side surface S7 and an image-side surface S8. The infrared filter L6 is arranged on the image-side surface of the third lens L3. The infrared filter L6 can filter out visible rays and only allow infrared rays to pass through, so that the optical imaging device 10 can also be used in a dark environment.

In some embodiment, the first lens L1, the second lens L2, and the third lens L3 are made of glass, and the infrared filter L4 is made of glass.

### First Embodiment

Referring to FIG. 1, the optical imaging device 10 includes, from the object side to the image side, a stop STO, a first lens L1 with a refractive power, a second lens L2 with a refractive power, a third lens L3 with a refractive power, and an infrared filter L4.

The object-side surface S1 of the first lens L1 is convex near the optical axis, and the image-side surface S2 of the first lens L1 is convex near the optical axis. The object-side surface S3 of the second lens L2 is concave near the optical axis, and the image-side surface S4 of the second lens L2 is convex near the optical axis. The object-side surface S5 of the third lens L3 is convex near the optical axis, and the image-side surface S6 of the third lens L3 is concave near the optical axis.

When the optical imaging device 10 is used, rays from the object side enter the optical imaging device 10, successively pass through the stop STO, the first lens L1, the second lens L2, the third lens L3, and the infrared filter L6, and finally converge on the image plane IMA.

Table 1 shows basic parameters of the optical imaging device 10.

TABLE 1

| | |
|---|---|
| Imgh (unit: mm) | 1.079 |
| TL1 (unit: mm) | 1.542 |
| TL2 (unit: mm) | 1.181 |
| TL3 (unit: mm) | 0.934 |
| V1 | 55.97818 |
| V2 | 20.3729 |
| V3 | 55.97818 |
| EPD (unit: mm) | 0.6 |
| f (unit: mm) | 1.31992 |

Wherein, TL1 is the distance between the object-side surface S1 of the first lens L1 and the image plane IMA of the optical imaging device 10 along the optical axis. TL2 is the distance between the object-side surface S3 of the second lens L2 and the image plane IMA of the optical imaging device 10 along the optical axis. TL3 is the distance between the object-side surface S5 of the third lens L3 and the image plane IMA of the optical imaging device 10 along the optical axis. For simplicity, these definitions apply generally to all embodiments.

Table 2 shows characteristics of the optical imaging device 10. The reference wavelength of focal length, refractive index, and Abbe number is 558 nm, and the units of radius of curvature, thickness, and semi-diameter are in millimeters (mm).

TABLE 2

| | | Type of | radius of | | refractive | Abbe | semi- |
|---|---|---|---|---|---|---|---|
| Surface | Lens | surface | curvature | thickness | index | number | diameter |
| object-side | | standard | infinite | 1000.000 | | | 817.260 |
| surface | | surface | | | | | |
| | | standard | infinite | 0.246 | | | 0.501 |
| | | surface | | | | | |
| STO | | standard | infinite | −0.030 | | | 0.300 |
| | | surface | | | | | |
| S1 | first | even aspheric | 0.825 | 0.242 | 1.54 | 56 | 0.340 |
| | lens | surface | | | | | |
| S2 | | even aspheric | 5.910 | 0.148 | | | 0.375 |
| | | surface | | | | | |
| S3 | second | even aspheric | −0.408 | 0.213 | 1.66 | 20.4 | 0.410 |
| | lens | surface | | | | | |
| S4 | | even aspheric | −0.546 | 0.050 | | | 0.450 |
| | | surface | | | | | |
| S5 | third | even aspheric | 0.679 | 0.197 | 1.54 | 56 | 0.560 |
| | lens | surface | | | | | |
| S6 | | even aspheric | 0.899 | 0.674 | | | 0.660 |
| | | surface | | | | | |
| S7 | infrared | standard | infinite | 0.110 | | | 1.079 |
| | filter | surface | | | | | |
| S8 | | standard | infinite | 0.150 | | | 1.079 |
| | | surface | | | | | |
| IMA | | standard | infinite | 0.000 | | | 1.079 |
| | | surface | | | | | |

Table 3 shows the aspherical coefficients of the optical imaging device 10.

TABLE 3
First embodiment

| surface | k | A2 | A4 | A6 | A8 | A10 | A12 | A14 | A16 |
|---|---|---|---|---|---|---|---|---|---|
| S1 | −1.158 | 0.000 | −0.072 | −5.432 | −24.402 | 21.2250 | 291.459 | −1.285E+004 | 109.739 |
| S2 | 243.327 | 0.000 | −1.427 | −7.949 | −13.765 | 62.963 | 671.809 | 3713.200 | −8212.029 |
| S3 | −1.939 | 0.000 | −0.695 | 3.358 | 42.829 | 222.211 | 373.075 | −5042.762 | −1.611E+004 |
| S4 | −1.287 | 0.000 | 0.015 | 6.178 | 22.839 | 28.824 | −107.755 | −722.100 | 634.989 |
| S5 | −8.327 | 0.000 | 0.011 | −1.814 | −1.579 | 3.056 | 3.952 | −33.517 | −215.566 |
| S6 | −8.023 | 0.000 | −0.300 | −0.451 | −0.795 | −1.047 | −0.539 | −0.047 | −3.179 |

It should be noted that the object-side surface and the image-side surface of each lens of the optical imaging device 10 may be aspherical. The aspherical equation of each aspherical surface satisfies the following formula (8):

$$Z = \frac{{cr}^{2}}{1 + \sqrt{1 - ( k + 1 ) {c}^{2} {r}^{2}}} + Σ {Air}^{i} . \qquad ( formula ( 8 ) )$$

Wherein, Z is a distance between any point on the aspheric surface and the vertex of the aspheric surface along the optical axis, r is a vertical distance from any point on the aspheric surface to the optical axis, c is a curvature (reciprocal of the radius of curvature) of the vertex, k is a conic constant, and Ai is a correction coefficient of i-th order of the aspheric surface. Table 3 shows the conic constant k and the high-order coefficients A2, A4, A6, A8, A10, A12, A14, and A16 for the surfaces S1 to S6 of each aspheric lens in the first embodiment.

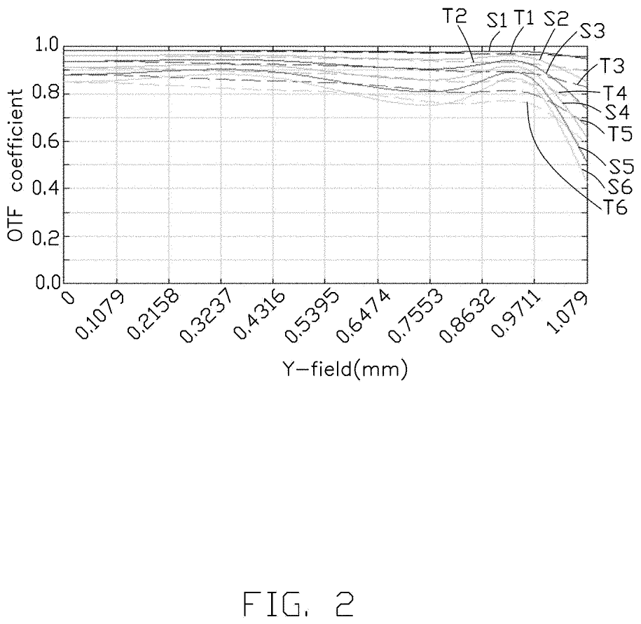

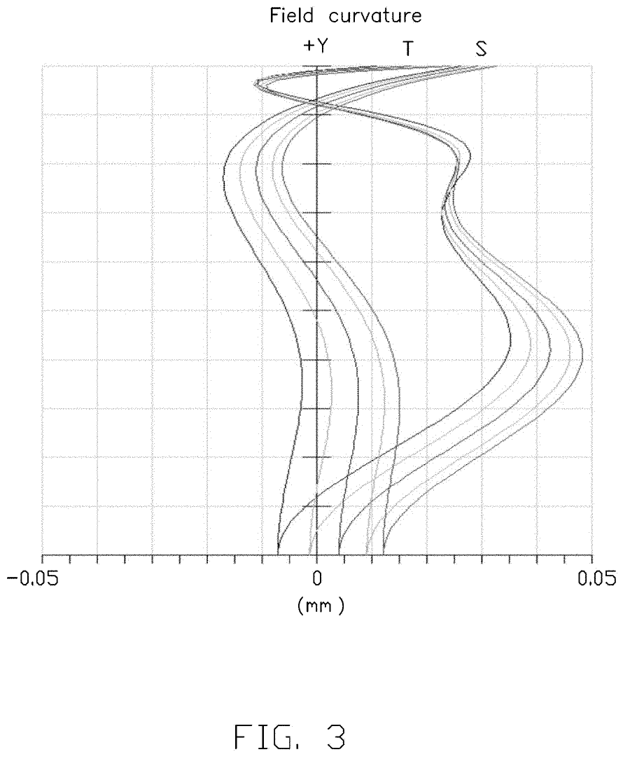

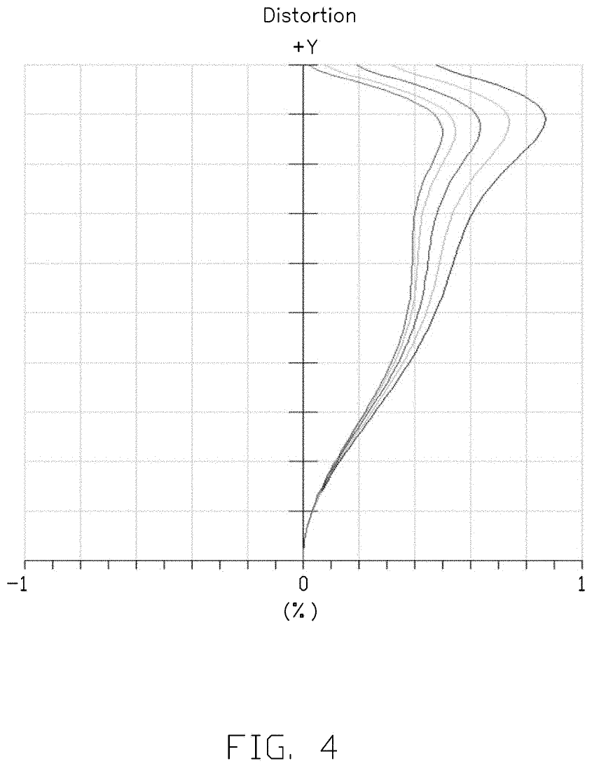

FIGS. 2 to 4 respectively show the MTF curves, the field curvatures, and the distortions of the optical imaging device 10 of the first embodiment. In FIG. 2, the abscissa represents Y-field offset angle, that is, an angle between the field of view of the optical imaging device 10 and the optical axis, and the ordinate represents the OTF coefficient. The curve at a lower frequency can reflect the contrast characteristics of the optical imaging device 10, and the curve at a higher frequency can reflect the resolution characteristics of the optical imaging device 10. FIG. 3 represents the meridian field curvature and the sagittal field curvature, in which the maximum value of each of the sagittal field curve and the meridional field curve is less than 0.05 mm, indicating that good compensation is obtained. The distortion curve in FIG. 4 shows the distortion values corresponding to different field angles, in which the maximum distortion is less than 1%, indicating that the distortion has been corrected. Therefore, the optical imaging device 10 can have a high imaging quality and low sensitivity.

### Second Embodiment

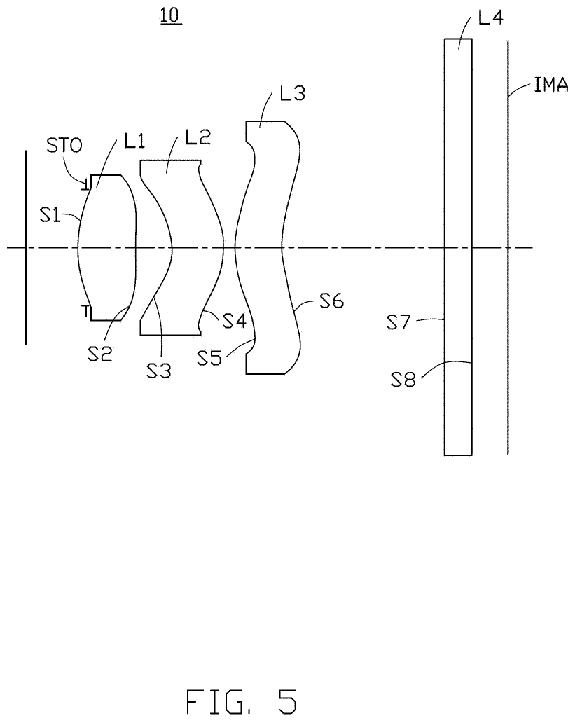

Referring to FIG. 5, the optical imaging device 10 includes, from the object side to the image side, a stop STO, a first lens L1 with a refractive power, a second lens L2 with a refractive power, a third lens L3 with a refractive power, and an infrared filter L4.

The object-side surface S1 of the first lens L1 is convex near the optical axis, and the image-side surface S2 of the first lens L1 is convex near the optical axis. The object-side surface S3 of the second lens L2 is concave near the optical axis, and the image-side surface S4 of the second lens L2 is convex near the optical axis. The object-side surface S5 of the third lens L3 is convex near the optical axis, and the image-side surface S6 of the third lens L3 is concave near the optical axis.

When the optical imaging device 10 is used, rays from the object side enter the optical imaging device 10, successively pass through the stop STO, the first lens L1, the second lens L2, the third lens L3, and the infrared filter L6, and finally converge on the image plane IMA.

Table 4 shows basic parameters of the optical imaging device 10.

TABLE 4

| | |
|---|---|
| Imgh (unit: mm) | 2.158 |
| TL1 (unit: mm) | 1.962 |
| TL2 (unit: mm) | 1.556 |
| TL3 (unit: mm) | 1.269 |
| V1 | 55.9782 |
| V2 | 20.3729 |
| V3 | 55.9782 |
| EPD (unit: mm) | 0.656 |
| f (unit: mm) | 1.35 |

It can be seen that when the aperture is 2.4 and the field of view is 1.0, the maximum image height of the optical imaging device is 2.158 mm.

Table 5 shows characteristics of the optical imaging device 10. The reference wavelength of focal length, refractive index, and Abbe number is 558 nm, and the units of radius of curvature, thickness, and semi-diameter are in millimeters (mm).

TABLE 5

| | | Type of | radius of | | refractive | Abbe | semi- |
|---|---|---|---|---|---|---|---|
| Surface | Lens | surface | curvature | thickness | index | number | diameter |
| object-side | | standard | infinite | 1000.000 | | | 799.685 |
| surface | | surface | | | | | |
| | | standard | infinite | 0.246 | | | 0.866 |
| | | surface | | | | | |
| STO | | standard | infinite | −0.030 | | | 0.328 |
| | | surface | | | | | |
| S1 | first | even aspheric | 0.876 | 0.242 | 1.54 | 56 | 0.380 |
| | lens | surface | | | | | |
| S2 | | even aspheric | −6.208 | 0.148 | | | 0.409 |
| | | surface | | | | | |
| S3 | second | even aspheric | −0.445 | 0.213 | 1.66 | 20.4 | 0.450 |
| | lens | surface | | | | | |
| S4 | | even aspheric | −0.578 | 0.050 | | | 0.500 |
| | | surface | | | | | |
| S5 | third | even aspheric | 0.688 | 0.197 | 1.54 | 56 | 0.600 |
| | lens | surface | | | | | |
| S6 | | even aspheric | 0.855 | 0.674 | | | 0.700 |
| | | surface | | | | | |
| S7 | infrared | standard | infinite | 0.110 | | | 1.079 |
| | filter | surface | | | | | |
| S8 | | standard | infinite | 0.150 | | | 1.079 |
| | | surface | | | | | |
| IMA | | standard | infinite | 0.000 | | | 1.079 |
| | | surface | | | | | |

Table 6 shows the aspherical coefficients of the optical imaging device 10.

TABLE 6
Second embodiment

| surface | k | A2 | A4 | A6 | A8 | A10 | A12 | A14 | A16 |
|---|---|---|---|---|---|---|---|---|---|
| S1 | −0.584 | 0.000 | −0.081 | −3.732 | −14.947 | 2.339 | 67.742 | −4374.640 | −5080.070 |
| S2 | 228.403 | 0.000 | −1.152 | −5.297 | −8.707 | 19.586 | 190.008 | 874.312 | −4652.002 |
| S3 | −1.960 | 0.000 | −0.701 | 1.770 | 21.865 | 103.925 | 164.819 | −1485.845 | −4279.661 |
| S4 | −1.160 | 0.000 | 0.014 | 3.825 | 12.360 | 13.312 | −39.390 | −239.835 | 333.785 |
| S5 | −8.830 | 0.000 | 0.028 | −1.336 | −1.169 | 0.710 | 1.376 | −11.641 | −81.884 |
| S6 | −7.613 | 0.000 | −0.254 | −0.335 | −0.484 | −0.542 | −0.247 | 0.226 | 0.210 |

It should be noted that the object-side surface and the image-side surface of each lens of the optical imaging device 10 may be aspherical. The aspherical equation of each aspherical surface is according to the formula (8):

$$Z = \frac{{cr}^{2}}{1 + \sqrt{1 - ( k + 1 ) {c}^{2} {r}^{2}}} + Σ {Air}^{i} . \qquad ( formula ( 8 ) )$$

Wherein, Z is the distance between any point on the aspheric surface and the vertex of the aspheric surface along the optical axis, r is the vertical distance from any point on the aspheric surface to the optical axis, c is the curvature (reciprocal of the radius of curvature) of the vertex, k is a conic constant, and Ai is a correction coefficient of i-th order of the aspheric surface. Table 6 shows the conic constant k and the high-order coefficients A2, A4, A6, A8, A10, A12, A14, and A16 for the surfaces S1 to S6 of each aspheric lens in the second embodiment.

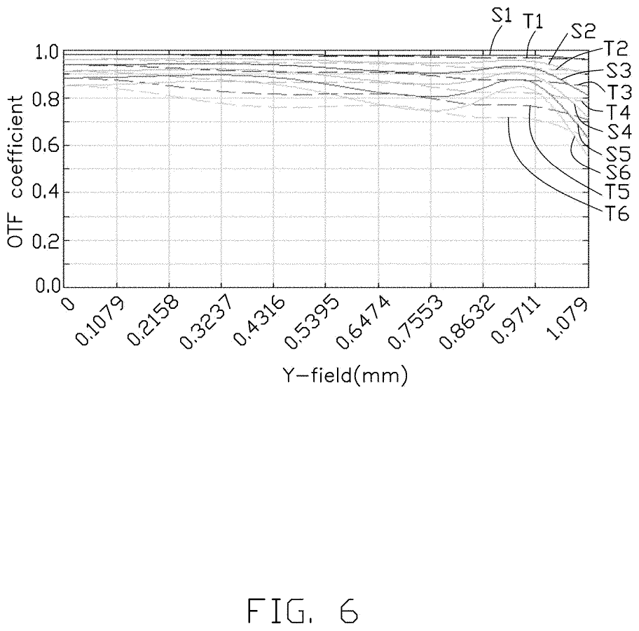

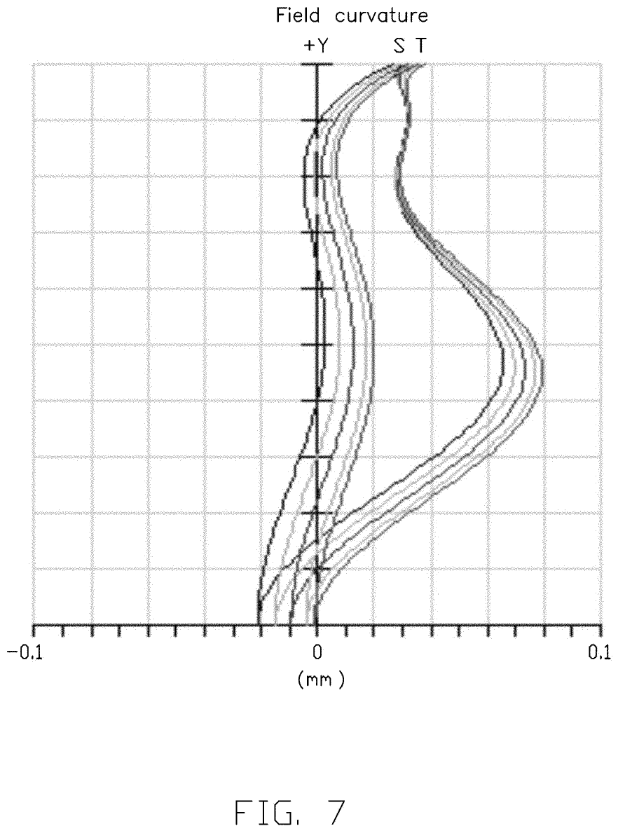

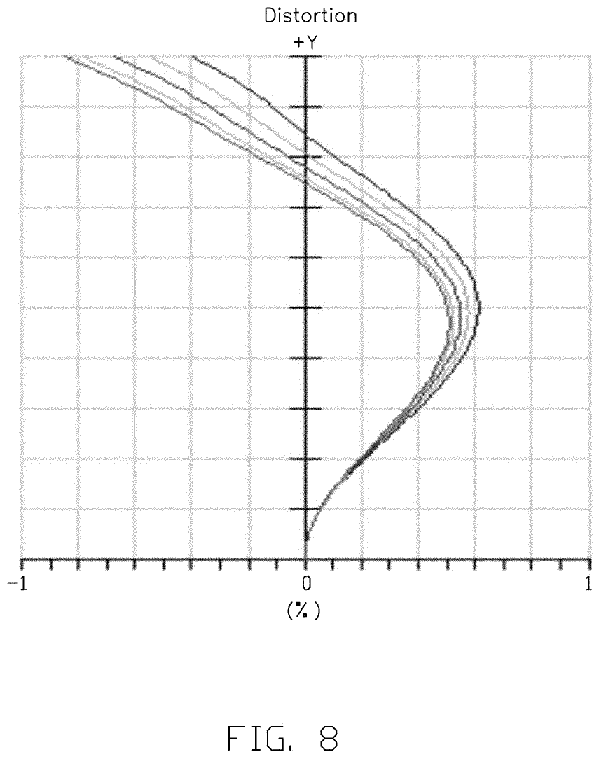

FIGS. 6 to 8 respectively show the MTF curves, the field curvatures, and the distortions of the optical imaging device 10 of the second embodiment. In FIG. 6, the abscissa represents Y-field offset angle, that is, an angle between the field of view of the optical imaging device 10 and the optical axis, and the ordinate represents the OTF coefficient. The curve at a lower frequency can reflect the contrast characteristics of the optical imaging device 10, and the curve at a higher frequency can reflect the resolution characteristics of the optical imaging device 10. FIG. 7 represents the meridian field curvature and the sagittal field curvature, in which the maximum value of each of the sagittal field curve and the meridional field curve is less than 0.1 mm, indicating that good compensation is obtained. The distortion curve in FIG. 8 shows the distortion values corresponding to different field angles, in which the maximum distortion is less than 1%, indicating that the distortion has been corrected. Therefore, the optical imaging device 10 can have a high imaging quality and low sensitivity.

### Third Embodiment

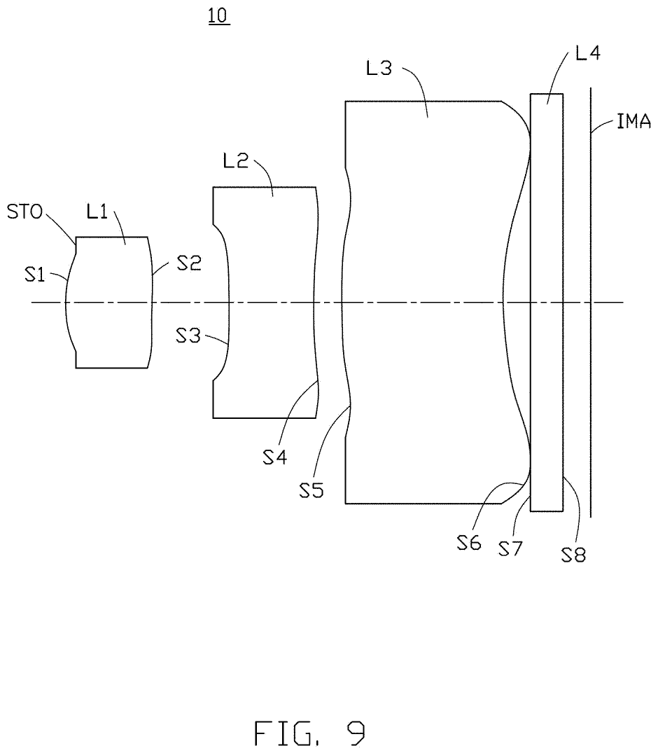

Referring to FIG. 9, the optical imaging device 10 includes, from the object side to the image side, a stop STO, a first lens L1 with a refractive power, a second lens L2 with a refractive power, a third lens L3 with a refractive power, and an infrared filter L4.

The object-side surface S1 of the first lens L1 is convex near the optical axis, and the image-side surface S2 of the first lens L1 is convex near the optical axis. The object-side surface S3 of the second lens L2 is concave near the optical axis, and the image-side surface S4 of the second lens L2 is convex near the optical axis. The object-side surface S5 of the third lens L3 is convex near the optical axis, and the image-side surface S6 of the third lens L3 is concave near the optical axis.

When the optical imaging device 10 is used, rays from the object side enter the optical imaging device 10, successively pass through the stop STO, the first lens L1, the second lens L2, the third lens L3, and the infrared filter L6, and finally converge on the image plane IMA.

Table 7 shows basic parameters of the optical imaging device 10.

TABLE 7

| | |
|---|---|
| Imgh (unit: mm) | 1.85 |
| TL1 (unit: mm) | 1.799 |
| TL2 (unit: mm) | 1.242 |
| TL3 (unit: mm) | 0.849 |
| V1 | 55.9782 |
| V2 | 55.9782 |
| V3 | 55.9782 |
| EPD (unit: mm) | 0.442 |
| f (unit: mm) | 1.34 |

Table 8 shows characteristics of the optical imaging device 10. The reference wavelength of focal length, refractive index, and Abbe number is 558 nm, and the units of radius of curvature, thickness, and semi-diameter are in millimeters (mm).

TABLE 8

| | | Type of | radius of | | refractive | Abbe | semi- |
|---|---|---|---|---|---|---|---|
| Surface | Lens | surface | curvature | thickness | index | number | diameter |
| object-side | | standard | infinite | 1000.000 | | | 669.741 |
| surface | | surface | | | | | |
| | | standard | infinite | | | | |
| | | surface | | | | | |
| STO | | standard | infinite | | | | 0.221 |
| | | surface | | | | | |
| S1 | first | even aspheric | 0.721 | 0.293 | 1.54 | 56 | 0.283 |
| | lens | surface | | | | | |
| S2 | | even aspheric | −199.187 | 0.264 | | | 0.338 |
| | | surface | | | | | |
| S3 | second | even aspheric | −9.181 | 0.293 | 1.66 | 20.4 | 0.503 |
| | lens | surface | | | | | |
| S4 | | even aspheric | −0.882 | 0.100 | | | 0.586 |
| | | surface | | | | | |
| S5 | third | even aspheric | −0.883 | 0.549 | 1.54 | 56 | 0.875 |
| | lens | surface | | | | | |
| S6 | | even aspheric | 1.826 | 0.100 | | | 0.894 |
| | | surface | | | | | |
| S7 | infrared | standard | infinite | 0.100 | | | 0.906 |
| | filter | surface | | | | | |
| S8 | | standard | infinite | 0.100 | | | 0.930 |
| | | surface | | | | | |
| IMA | | standard | infinite | 0.000 | | | 0.930 |
| | | surface | | | | | |

Table 9 shows the aspherical coefficients of the optical imaging device 10.

TABLE 9

| surface | k | A2 | A4 | A6 | A8 |
|---|---|---|---|---|---|
| S1 | −28.550 | 0.000 | 5.806 | −54.211 | 136.435 |
| S2 | −1.989E+012 | 0.000 | −1.780 | −5.350 | −43.135 |
| S3 | −1.329E+009 | 0.000 | −2.037 | −0.410 | −161.577 |
| S4 | −2.507E+006 | 0.000 | 3.339 | −23.969 | 44.120 |
| S5 | −1.906E+006 | 0.000 | 2.390 | −11.293 | 13.426 |
| S6 | −0.450 | 0.000 | −0.039 | 0.068 | −0.679 |

It should be noted that the object-side surface and the image-side surface of each lens of the optical imaging device 10 may be aspherical. The aspherical equation of each aspherical surface is according to the formula (8):

$$Z = \frac{{cr}^{2}}{1 + \sqrt{1 - ( k + 1 ) {c}^{2} {r}^{2}}} + Σ {Air}^{i} . \qquad ( formula ( 8 ) )$$

Wherein, Z is the distance between any point on the aspheric surface and the vertex of the aspheric surface along the optical axis, r is the vertical distance from any point on the aspheric surface to the optical axis, c is the curvature (reciprocal of the radius of curvature) of the vertex, k is a conic constant, and Ai is a correction coefficient of i-th order of the aspheric surface. Table 9 shows the conic constant k and the high-order coefficients A2, A4, A6, and A8 for the surfaces S1 to S6 of each aspheric lens in the third embodiment.

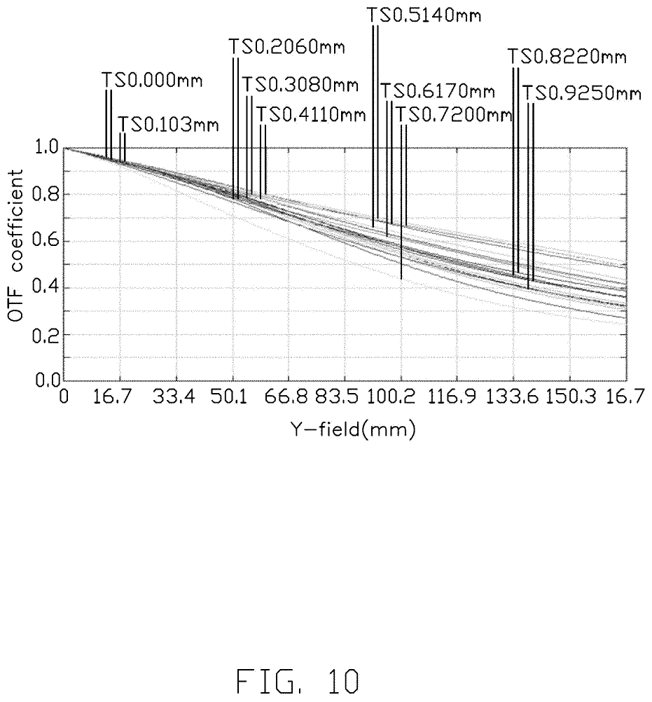

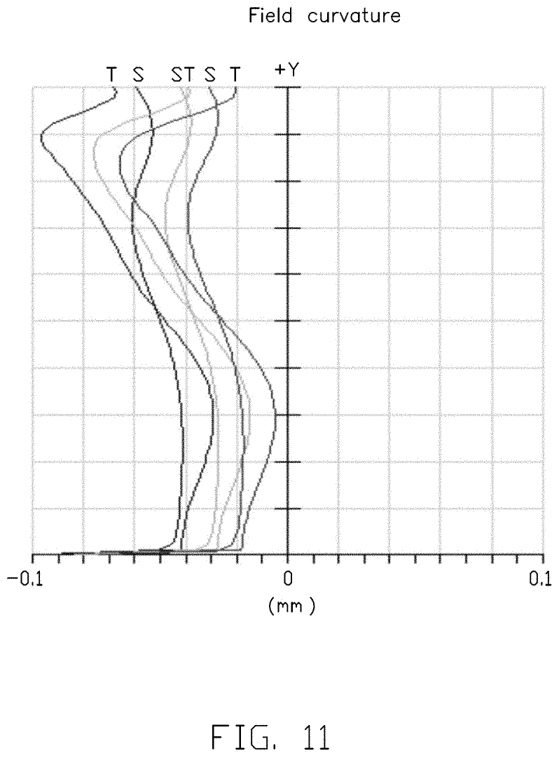

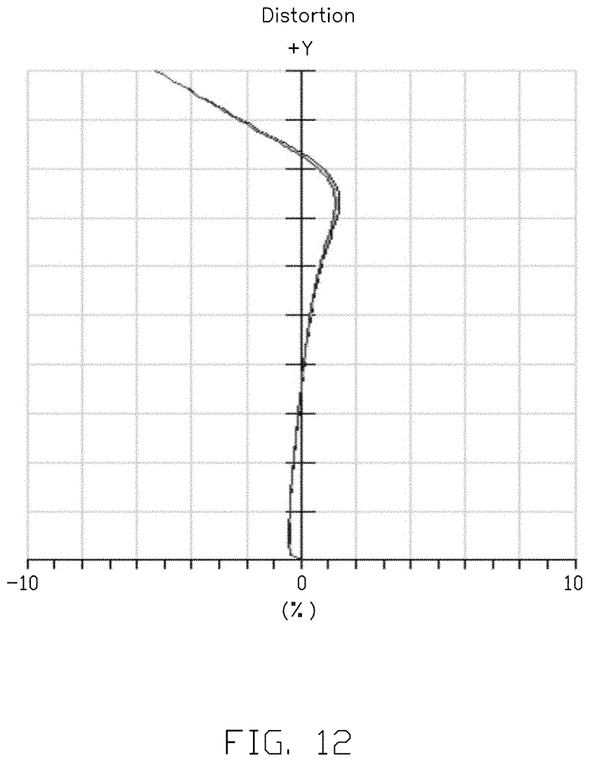

FIGS. 10 to 12 respectively show the MTF curves, the field curvatures, and the distortions of the optical imaging device 10 of the third embodiment. In FIG. 10, the abscissa represents Y-field offset angle, that is, an angle between the field of view of the optical imaging device 10 and the optical axis, and the ordinate represents the OTF coefficient. The curve at a lower frequency reflects the contrast characteristics of the optical imaging device 10, and the curve at a higher frequency reflects the resolution characteristics of the optical imaging device 10. FIG. 11 represents the meridian field curvature and the sagittal field curvature, in which the maximum value of each of the sagittal field curve and the meridional field curve is less than 0.1 mm, indicating that good compensation is obtained. The distortion curve in FIG. 12 shows the distortion values corresponding to different field angles, in which the maximum distortion is less than 1%, indicating that the distortion has been corrected. Therefore, the optical imaging device 10 can have a high imaging quality and low sensitivity.

### Fourth Embodiment

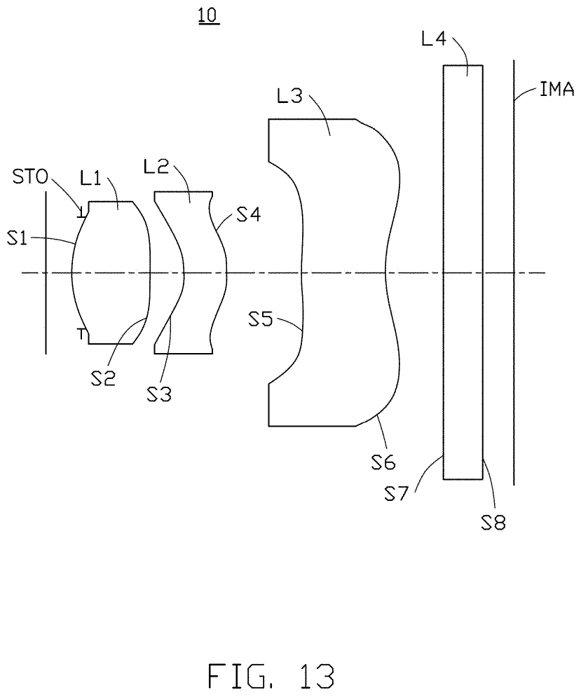

Referring to FIG. 13, the optical imaging device 10 includes, from the object side to the image side, a stop STO, a first lens L1 with a refractive power, a second lens L2 with a refractive power, a third lens L3 with a refractive power, and an infrared filter L4.

The object-side surface S1 of the first lens L1 is convex near the optical axis, and the image-side surface S2 of the first lens L1 is convex near the optical axis. The object-side surface S3 of the second lens L2 is concave near the optical axis, and the image-side surface S4 of the second lens L2 is convex near the optical axis. The object-side surface S5 of the third lens L3 is convex near the optical axis, and the image-side surface S6 of the third lens L3 is concave near the optical axis.

When the optical imaging device 10 is used, rays from the object side enter the optical imaging device 10, successively pass through the stop STO, the first lens L1, the second lens L2, the third lens L3, and the infrared filter L6, and finally converge on the image plane IMA.

Table 10 shows basic parameters of the optical imaging device 10.

TABLE 10

| | |
|---|---|
| Imgh (unit: mm) | 1.079 |
| TL1 (unit: mm) | 1.4358 |
| TL2 (unit: mm) | 1.1345 |
| TL3 (unit: mm) | 0.8375 |
| V1 | 55.978178 |
| V2 | 20.372904 |
| V3 | 55.978178 |
| EPD (unit: mm) | 0.575786 |
| f (unit: mm) | 1.38189 |

Table 11 shows characteristics of the optical imaging device 10. The reference wavelength of focal length, refractive index, and Abbe number is 558 nm, and the units of radius of curvature, thickness, and semi-diameter are in millimeters (mm).

TABLE 11

| | | Type of | radius of | | refractive | Abbe | semi- |
|---|---|---|---|---|---|---|---|
| Surface | Lens | surface | curvature | thickness | index | number | diameter |
| object-side | | standard | infinite | 300.000 | | | 224.240 |
| surface | | surface | | | | | |
| | | standard | infinite | 0.145 | | | 0.420 |
| | | surface | | | | | |
| STO | | standard | infinite | −0.041 | | | 0.288 |
| | | surface | | | | | |
| S1 | first | even aspheric | 0.722 | 0.308 | 1.54 | 56 | 0.318 |
| | lens | surface | | | | | |
| S2 | | even aspheric | −2.387 | 0.133 | | | 0.368 |
| | | surface | | | | | |
| S3 | second | even aspheric | −0.451 | 0.168 | 1.66 | 20.4 | 0.372 |
| | lens | surface | | | | | |
| S4 | | even aspheric | −0.542 | 0.297 | | | 0.416 |
| | | surface | | | | | |
| S5 | third | even aspheric | 2.181 | 0.331 | 1.54 | 56 | 0.576 |
| | lens | surface | | | | | |
| S6 | | even aspheric | 0.886 | 0.231 | | | 0.799 |
| | | surface | | | | | |
| S7 | infrared | standard | infinite | 0.150 | | | 1.002 |
| | filter | surface | | | | | |
| S8 | | standard | infinite | 0.126 | | | 1.070 |
| | | surface | | | | | |
| IMA | | standard | infinite | 0.000 | | | 1.101 |
| | | surface | | | | | |

Table 12 shows the aspherical coefficients of the optical imaging device 10.

TABLE 12
Fourth embodiment

| surface | k | A2 | A4 | A6 | A8 | A10 | A12 | A14 | A16 |
|---|---|---|---|---|---|---|---|---|---|
| S1 | −5.257 | 0.000 | 1.047 | −9.508 | 80.914 | −445.569 | 6636.571 | −3.243E+005 | 2.510E+006 |
| S2 | −282.000 | 0.000 | −2.913 | −14.606 | 257.682 | 205.844 | −2.277E+004 | 1.136E+005 | −1.605E+005 |
| S3 | −1.560 | 0.000 | −1.144 | 14.792 | 161.704 | 1324.673 | −1.789E+004 | −3.739E+004 | 3.426E+005 |
| S4 | −2.212 | 0.000 | −0.245 | 15.138 | 45.344 | 105.348 | 1463.832 | −2.359E+004 | 2.889E+004 |
| S5 | −59.719 | 0.000 | −1.492 | −0.283 | 13.688 | −47.277 | −82.055 | 552.463 | −790.788 |
| S6 | −5.668 | 0.000 | −1.153 | 1.113 | 0.794 | −3.316 | −6.312 | 18.815 | −12.173 |

It should be noted that the object-side surface and the image-side surface of each lens of the optical imaging device 10 may be aspherical. The aspherical equation of each aspherical surface is according to the formula (8):

$$Z = \frac{{cr}^{2}}{1 + \sqrt{1 - ( k + 1 ) {c}^{2} {r}^{2}}} + Σ {Air}^{i} . \qquad ( formula ( 8 ) )$$

Wherein, Z is the distance between any point on the aspheric surface and the vertex of the aspheric surface along the optical axis, r is the vertical distance from any point on the aspheric surface to the optical axis, c is the curvature (reciprocal of the radius of curvature) of the vertex, k is a conic constant, and Ai is a correction coefficient of i-th order of the aspheric surface. Table 12 shows the conic constant k and the high-order coefficients A2, A4, A6, A8, A10, A12, A14, and A16 for the surfaces S1 to S6 of each aspheric lens in the fourth embodiment.

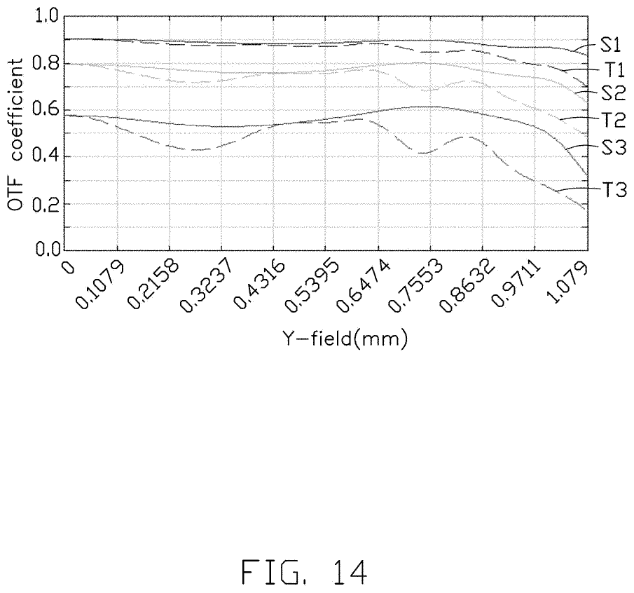

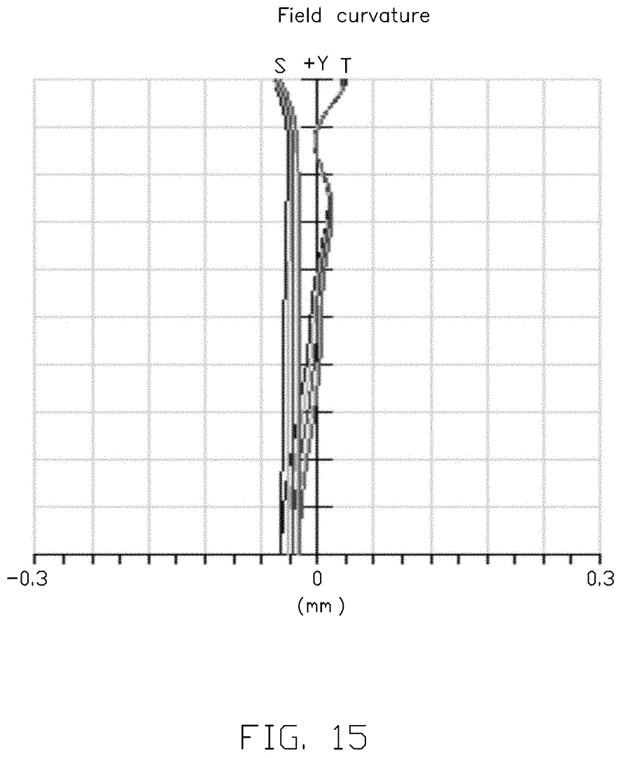

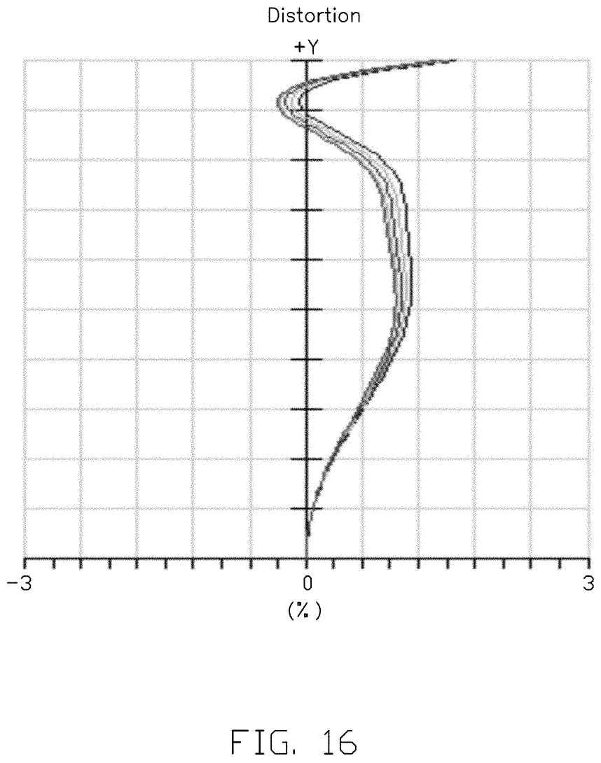

FIGS. 14 to 16 respectively show the MTF curves, the field curvatures, and the distortions of the optical imaging device 10 of the fourth embodiment. In FIG. 14, the abscissa represents Y-field offset angle, that is, an angle between the field of view of the optical imaging device 10 and the optical axis, and the ordinate represents the OTF coefficient. The curve at a lower frequency reflects the contrast characteristics of the optical imaging device 10, and the curve at a higher frequency reflects the resolution characteristics of the optical imaging device 10. FIG. 15 represents the meridian field curvature and the sagittal field curvature, in which the maximum value of each of the sagittal field curve and the meridional field curve is less than 0.3 mm, indicating that good compensation is obtained. The distortion curve in FIG. 16 shows the distortion values corresponding to different field angles, in which the maximum distortion is less than 3%, indicating that the distortion has been corrected. Therefore, the optical imaging device 10 can have a high imaging quality and low sensitivity.

### Fifth Embodiment

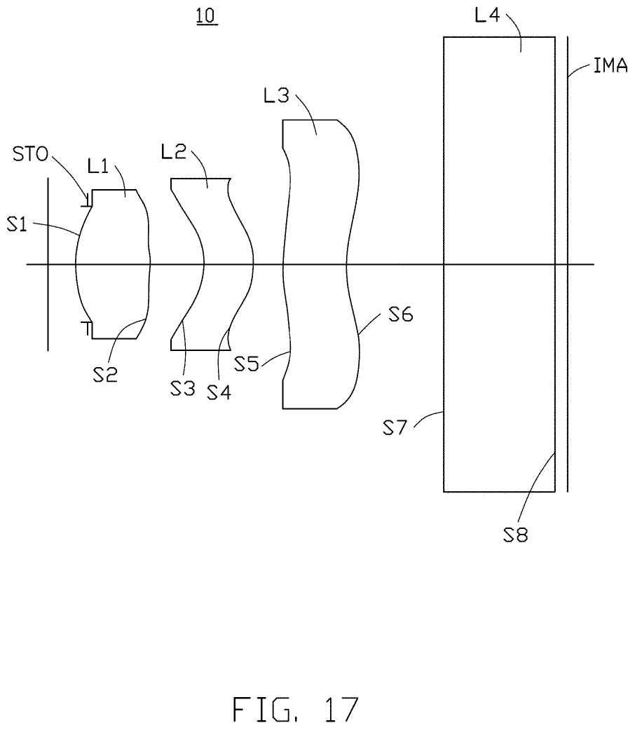

Referring to FIG. 17, the optical imaging device 10 includes, from the object side to the image side, a stop STO, a first lens L1 with a refractive power, a second lens L2 with a refractive power, a third lens L3 with a refractive power, and an infrared filter L4.

The object-side surface S1 of the first lens L1 is convex near the optical axis, and the image-side surface S2 of the first lens L1 is convex near the optical axis. The object-side surface S3 of the second lens L2 is concave near the optical axis, and the image-side surface S4 of the second lens L2 is convex near the optical axis. The object-side surface S5 of the third lens L3 is convex near the optical axis, and the image-side surface S6 of the third lens L3 is concave near the optical axis.

When the optical imaging device 10 is used, rays from the object side enter the optical imaging device 10, successively pass through the stop STO, the first lens L1, the second lens L2, the third lens L3, and the infrared filter L6, and finally converge on the image plane IMA.

Table 13 shows basic parameters of the optical imaging device 10.

TABLE 13

| | |
|---|---|
| Imgh (unit: mm) | 1.079 |
| TL1 (unit: mm) | 1.5234 |
| TL2 (unit: mm) | 1.1455 |
| TL3 (unit: mm) | 0.8065 |
| V1 | 55.978178 |
| V2 | 20.372904 |
| V3 | 55.978178 |
| EPD (unit: mm) | 0.559785 |
| f (unit: mm) | 1.34348 |

Table 14 shows characteristics of the optical imaging device 10. The reference wavelength of focal length, refractive index, and Abbe number is 558 nm, and the units of radius of curvature, thickness, and semi-diameter are in millimeters (mm).

TABLE 14

| | | Type of | radius of | | refractive | Abbe | semi- |
|---|---|---|---|---|---|---|---|
| Surface | Lens | surface | curvature | thickness | index | number | diameter |
| object-side | | standard | infinite | infinite | | | infinite |
| surface | | surface | | | | | |
| | | standard | infinite | 0.145 | | | 0.408 |
| | | surface | | | | | |
| STO | | standard | infinite | −0.040 | | | 0.280 |
| | | surface | | | | | |
| S1 | first | even aspheric | 0.729 | 0.266 | 1.54 | 56 | 0.304 |
| | lens | surface | | | | | |
| S2 | | even aspheric | −5.516 | 0.200 | | | 0.351 |
| | | surface | | | | | |
| S3 | second | even aspheric | −0.385 | 0.178 | 1.66 | 20.4 | 0.363 |
| | lens | surface | | | | | |
| S4 | | even aspheric | −0.427 | 0.110 | | | 0.406 |
| | | surface | | | | | |
| S5 | third | even aspheric | 1.137 | 0.229 | 1.54 | 56 | 0.555 |
| | lens | surface | | | | | |
| S6 | | even aspheric | 0.769 | 0.356 | | | 0.685 |
| | | surface | | | | | |
| S7 | infrared | standard | infinite | 0.400 | | | 0.893 |
| | filter | surface | | | | | |
| S8 | | standard | infinite | 0.050 | | | 1.079 |
| | | surface | | | | | |
| IMA | | standard | infinite | 0.000 | | | 1.079 |
| | | surface | | | | | |

Table 15 shows the aspherical coefficients of the optical imaging device 10.

TABLE 15
Fifth embodiment

| surface | k | A2 | A4 | A6 | A8 | A10 | A12 | A14 | A16 |
|---|---|---|---|---|---|---|---|---|---|
| S1 | −4.207 | 0.000 | 0.920 | −13.727 | 136.080 | −721.458 | 586.898 | −2.136E+005 | 2.029E+006 |
| S2 | 122.802 | 0.000 | −1.573 | −1.740 | −48.907 | −700.712 | 1.151E+004 | 6.071E+004 | −9.005E+005 |
| S3 | −1.759 | 0.000 | −0.873 | 16.878 | 83.256 | 293.692 | −3950.573 | −1.965E+004 | 2.170E+004 |
| S4 | −1.685 | 0.000 | −0.131 | 17.590 | 32.397 | 2.264 | 232.911 | −3047.351 | −1.594E+004 |
| S5 | −58.342 | 0.000 | −0.262 | −2.149 | 4.082 | 5.517 | −20.261 | 60.607 | −255.096 |
| S6 | −14.773 | 0.000 | −0.952 | 1.437 | −1.575 | −5.295 | 4.710 | 36.400 | −62.096 |

It should be noted that the object-side surface and the image-side surface of each lens of the optical imaging device 10 may be aspherical. The aspherical equation of each aspherical surface is according to the formula (8).

$$Z = \frac{{cr}^{2}}{1 + \sqrt{1 - ( k + 1 ) {c}^{2} {r}^{2}}} + Σ {Air}^{i} . \qquad ( formula ( 8 ) )$$

Wherein, Z is the distance between any point on the aspheric surface and the vertex of the aspheric surface along the optical axis, r is the vertical distance from any point on the aspheric surface to the optical axis, c is the curvature (reciprocal of the radius of curvature) of the vertex, k is a conic constant, and Ai is a correction coefficient of i-th order of the aspheric surface. Table 12 shows the conic constant k and the high-order coefficients A2, A4, A6, A8, A10, A12, A14, and A16 for the surfaces S1 to S6 of each aspheric lens in the fifth embodiment.

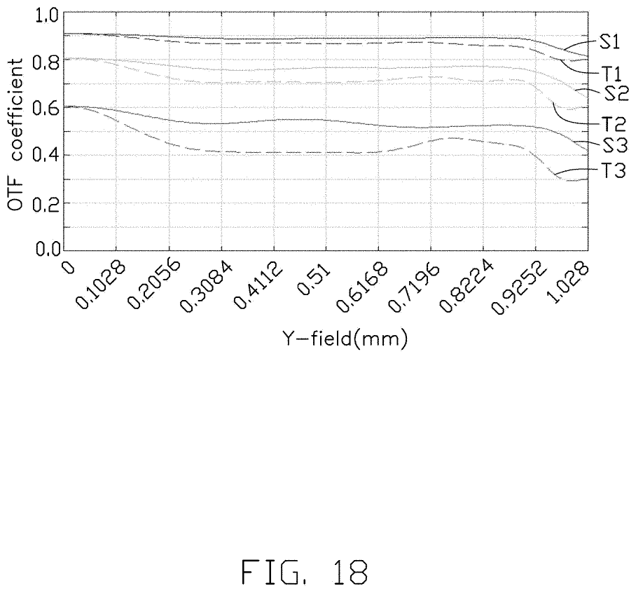

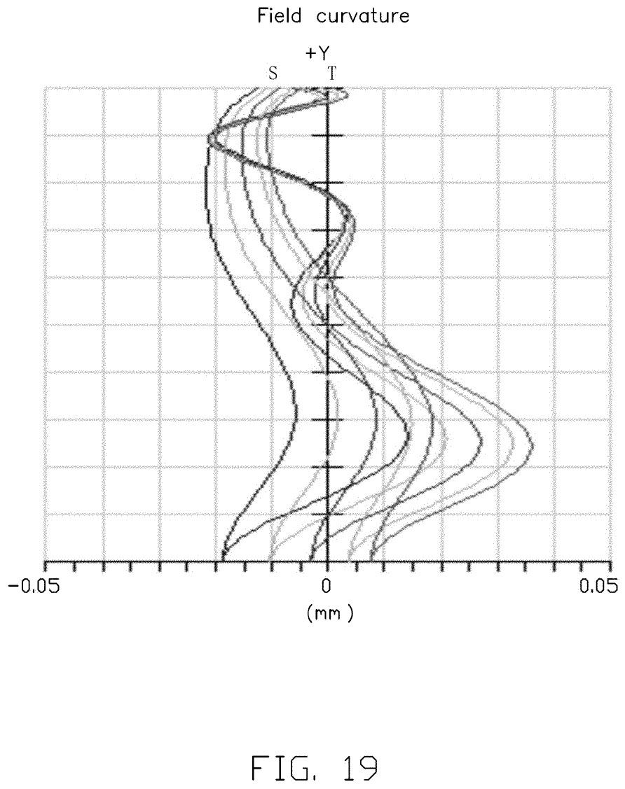

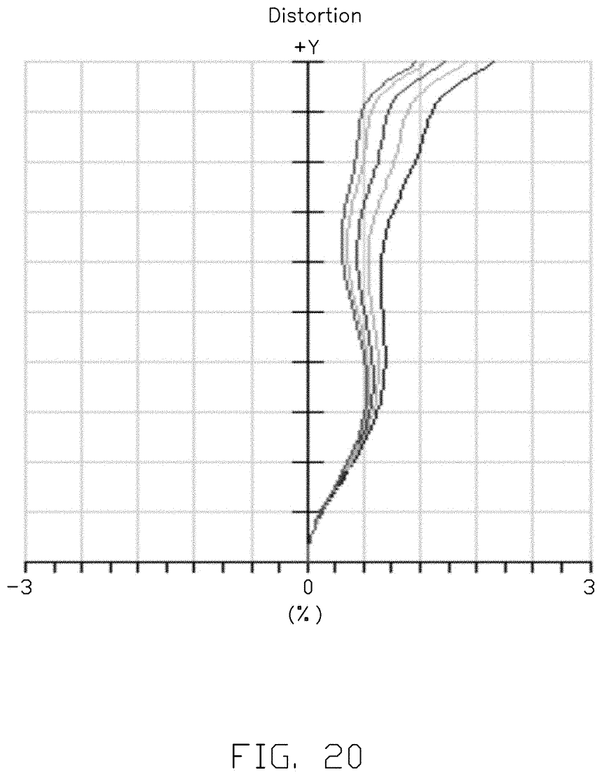

FIGS. 18 to 20 respectively show the MTF curves, the field curvatures, and the distortions of the optical imaging device 10 of the fifth embodiment. In FIG. 18, the abscissa represents Y-field offset angle, that is, an angle between the field of view of the optical imaging device 10 and the optical axis, and the ordinate represents the OTF coefficient. The curve at a lower frequency can reflect the contrast characteristics of the optical imaging device 10, and the curve at a higher frequency can reflect the resolution characteristics of the optical imaging device 10. FIG. 19 represents the meridian field curvature and the sagittal field curvature, in which the maximum value of each of the sagittal field curve and the meridional field curve is less than 0.05 mm, indicating that good compensation is obtained. The distortion curve in FIG. 20 shows the distortion values corresponding to different field angles, in which the maximum distortion is less than 3%, indicating that the distortion has been corrected. Therefore, the optical imaging device 10 can have a high imaging quality and low sensitivity.

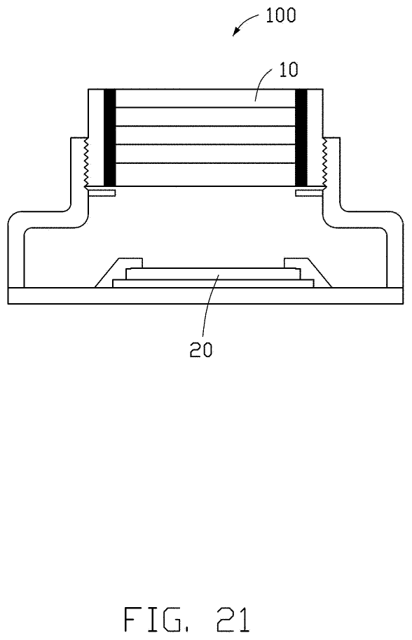

Referring to FIG. 21, an embodiment of an imaging module 100 is further provided, which includes the optical imaging device 10 and an optical sensor 20. The optical sensor 20 is arranged on the image side of the optical imaging device 10.

The optical sensor 20 can be a CMOS (complementary metal oxide semiconductor) sensor or a charge coupled device (CCD).

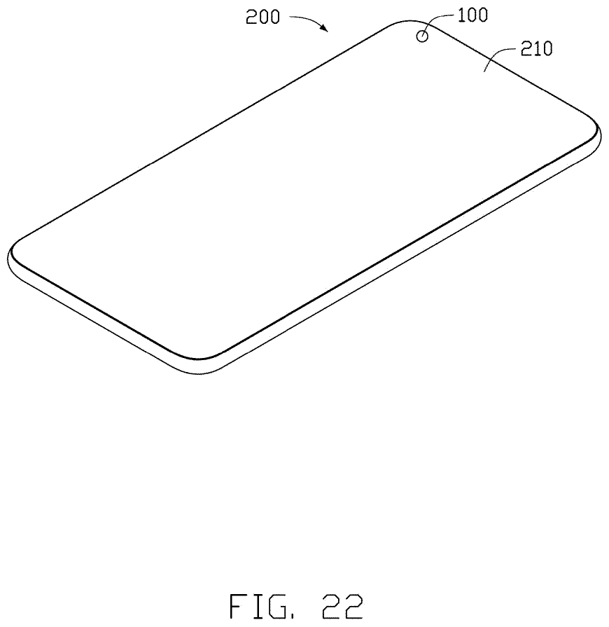

Referring to FIG. 22, an embodiment of an electronic device 200 includes the imaging module 100 and a housing 210. The imaging module 100 is mounted on the housing 210.

The electronic device 200 can be a smart phone, a tablet computer, a notebook computer, an e-book reader, a portable multimedia player (PMP), a portable telephone, a video telephone, a digital camera, a mobile medical device, or a wearable device, etc.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present exemplary embodiments, to the full extent indicated by the plain meaning of the terms in which the appended claims are expressed.

What is claimed is:

1. An optical imaging device, from an object side to an image side, comprising:
a first lens having a refractive power;
a second lens having a refractive power; and
a third lens having a refractive power;
wherein the optical imaging device satisfies the following formulas:
0 mm<R11<1 mm, −5%<DIS<5%, V1≥V2, and V3≥V2;
wherein, R11 is a radius of curvature of an object-side surface of the first lens, DIS is optical distortion of the optical imaging device, V1 is a dispersion coefficient of the first lens, V2 is a dispersion coefficient of the second lens, and V3 is a dispersion coefficient of the third lens.

2. The optical imaging device of claim 1, further satisfying the following formulas:
0.1<P11<1, −10<P2<1, and P3>−2;
wherein, P11 is a refractive power of the object-side surface of the first lens, P2 is the refractive power of the second lens, P3 is the refractive power of the third lens.

3. The optical imaging device of claim 1, further satisfying the following formula:
0.78<Imgh/f<1.60;
wherein, Imgh is an image height corresponding to a half of a maximum field of view of the optical imaging device, and f is an effective focal length of the optical imaging device.

4. The optical imaging device of claim 1, further satisfying the following formula:
1.36<(V2+V3)/V1<1.45.

5. The optical imaging device of claim 1, further satisfying the following formula:
1.04<TL1/f<1.45;
wherein TL1 is a distance from the object-side surface of the first lens to an image plane of the optical imaging device along an optical axis of the optical imaging device, and f is an effective focal length of the optical imaging device.

6. The optical imaging device of claim 1, further satisfying the following formula:
1.04<TL1/f<1.45;
wherein TL1 is a distance from the object-side surface of the first lens to an image plane of the optical imaging device along an optical axis of the optical imaging device, and f is an effective focal length of the optical imaging device.

7. The optical imaging device of claim 1, further satisfying the following formula:
0.36<V2/V3<1.

8. The optical imaging device of claim 1, wherein an object-side surface of the third lens is convex near an optical axis of the optical imaging device, and an image-side surface of the third lens is concave near the optical axis.

9. An imaging module, comprising:
an optical imaging device, from an object side to an image side, composed of:
a first lens having a refractive power;
a second lens having a refractive power; and
a third lens having a refractive power; and
an optical sensor arranged on the image side of the optical imaging device;
wherein the optical imaging device satisfies the following formula:
0 mm<R11<1 mm, −5%<DIS<5%, V1≥V2, V3≥V2;
wherein, R11 is a radius of curvature of an object-side surface of the first lens, DIS is optical distortion of the optical imaging device, V1 is a dispersion coefficient of the first lens, V2 is a dispersion coefficient of the second lens, and V3 is a dispersion coefficient of the third lens.

10. The imaging module of claim 9, wherein the optical imaging device further satisfies the following formula:
0.1<P11<1, −10<P2<1, P3>−2;
wherein, P11 is a refractive power of the object-side surface of the first lens, P2 is the refractive power of the second lens, P3 is the refractive power of the third lens.

11. The imaging module of claim 9, wherein the optical imaging device further satisfies the following formula:
0.78<Imgh/f<1.60;
wherein, Imgh is an image height corresponding to a half of a maximum field of view of the optical imaging device, and f is an effective focal length of the optical imaging device.

12. The imaging module of claim 9, wherein the optical imaging device further satisfies the following formula:
1.36<(V2+V3)/V1<1.45.

13. The imaging module of claim 9, wherein the optical imaging device further satisfies the following formula:
1.04<TL1/f<1.45;
wherein TL1 is a distance from the object-side surface of the first lens to an image plane of the optical imaging device along an optical axis of the optical imaging device, and f is an effective focal length of the optical imaging device.

14. The imaging module of claim 9, wherein the optical imaging device further satisfies the following formula:
1.04<TL1/f<1.45;
wherein TL1 is a distance from the object-side surface of the first lens to an image plane of the optical imaging device along an optical axis of the optical imaging device, and f is an effective focal length of the optical imaging device.

15. The imaging module of claim 9, wherein the optical imaging device further satisfies the following formula:
0.36<V2/V3<1.

16. The imaging module of claim 9, wherein an object-side surface of the third lens is convex near an optical axis of the optical imaging device, and an image-side surface of the third lens is concave near the optical axis.

17. An imaging module, comprising:
a housing; and
an imaging module mounted on the housing, the imaging module comprising:
an optical imaging device, from an object side to an image side, comprising:
a first lens having a refractive power;
a second lens having a refractive power; and
a third lens having a refractive power; and
an optical sensor arranged on the image side of the optical imaging device;
wherein the optical imaging device satisfies the following formula:
0 mm<R11<1 mm, −5%<DIS<5%, V1≥V2, V3≥V2;
wherein, R11 is a radius of curvature of an object-side surface of the first lens, DIS is optical distortion of the optical imaging device, V1 is a dispersion coefficient of the first lens, V2 is a dispersion coefficient of the second lens, and V3 is a dispersion coefficient of the third lens.

18. The electronic device of claim 17, wherein the optical imaging device further satisfies the following formulas:
0.1<P11<1, −10<P2<1, and P3>−2;
wherein, P11 is a refractive power of the object-side surface of the first lens, P2 is the refractive power of the second lens, P3 is the refractive power of the third lens.

19. The electronic device of claim 17, wherein the optical imaging device further satisfies the following formula:
0.78<Imgh/f<1.60;
wherein, Imgh is an image height corresponding to a half of a maximum field of view of the optical imaging device, and f is an effective focal length of the optical imaging device.

20. The electronic device of claim 17, wherein the optical imaging device further satisfies the following formula:
1.36<(V2+V3)/V1<1.45.
